(19) United States
(12) Patent Application Publication
(10) Pub. No.: US 2003/0226206 A1
(43) Pub. Date: Dec. 11, 2003

(54) AUTOMATIC PATIENT TURNER

(76) Inventor: Michael Ben-Levi, West Holly Wood, CA (US)

Correspondence Address: Dr. Michael Ben-Levi, 8490 Fountain Avenue, #102, West Hollywood, CA, 90069, US

(21) Appl. No.: 10/165,703

(22) Filed: Jun. 8, 2002

(51) Int. Cl. A61G 7/057

(52) U.S. Cl. 5/615

(57) ABSTRACT

This invention will alternately turn an immobile, bedridden patient 180 degrees. It is designed to prevent bedsores and the accumulation of fluid in the lungs. The device consists of five strategically placed inflatables on a flexible mattress assembly strapped to a hospital bed mattress. The knees are bent in a perpendicular, 90° position and sandwiched between a pair of inflated knee bags on top of the flexible mattress. The inflation of one of the elongated air bags beneath the flexible mattress raises that longitudinal side of the mattress to a 45° incline. This causes the knees to move from a 90° angle relative to the flat mattress an additional 45 degrees to a 135° angle. As those air bags deflate, the bent knees descend. Acting as a lever arm, the knees pull the body completely to the side of the turn, while a back support air bag pillow inflates.

### FIELD OF INVENTION

The TURNAMATIC™ Automatic Patient Turner falls within class 5—beds, subclass 607—tiltable along a longitudinal axis. It will alternately turn a patient a full 180 degrees. Five inflatables are strategically placed on a flexible mattress assembly. On the top of the assembly is a flexible mattress, and beneath it is a twin chamber containing a right and a left elongated inflatable along the longitudinal axis of the flexible mattress. The flexible mattress and the twin chamber are both attached to an underneath pad that is strapped to a hospital bed mattress or frame. The alternate inflation and deflation of the two elongated air bags will alternately tilt a patient. Tilting a patient on an approximate 45° incline is the first step in the turning process.

On the top of the flexible mattress are two inflatables, one positioned on each side of the patient's knees. The knees are bent and sandwiched between the two inflated knee air bags and are in a perpendicular position where they are on a 90° angle relative to the flat flexible mattress. When one longitudinal side of the flexible mattress begins to rise to an approximate 45° incline due to the inflation of the elongated air bag beneath it, the patient's bent knees also move 45 degrees to a point 135 degrees relative to the flexible mattress when it was in a flat position.

After being fully inflated, the elongated air bag and the two knee air bags begin to deflate. Being 45 degrees past the midpoint, the bent knees begin to descend. Acting as a lever arm, the bent knees pull the entire body of the patient in the direction of the turn. An hour later, the patient is turned to the other side.

### DESCRIPTION OF THE PRIOR ART

The Automatic Patient Turner, as well as three prior inventions, alternately tilt a patient due to the alternate inflation and deflation of a right and a left inflatable along the longitudinal axis of the bed, mattress, or mat assembly. This concept is now in the public domain. What is being elevated by the alternate inflation and deflation of a right and left inflatable along the longitudinal axis is what differentiates these four inventions.

De Mare's Clinical Manipulator [U.S. Pat. No. 3,717,885-2/73] tilts a patient from side to side by the alternate inflation and deflation of a right and a left elongated inflatable underneath and along the longitudinal axis of a hospital bed mattress. Bruno and Peitras' Patient Turning Apparatus [U.S. Pat. No. 3,775,781-12/73] has the patient lying directly upon a two sectional air mattress that is strapped to the top of a hospital bed mattress. Watanabe's Tiltable Mat Assembly [U.S. Pat. No. 4,934,002-6/90] also uses a right and left inflatable to raise and lower a cradle-like mat assembly along its longitudinal axis.

The fundamental difference between the Automatic Patient Turner and the Clinical Manipulator, the invention closest to TURNAMATIC™, can be readily seen because a figure from each invention is shown in FIG. 1 and FIG. 2, respectively, on page 1/5 of the diagrams. Whereas De Mare's Clinical Manipulator uses a rigid hospital bed mattress in his invention, the Automatic Patient Turner uses a flexible mattress strapped to a hospital bed mattress. Watanabe's Tiltable Mat Assembly has the patient lying on a non-flexible surface.

When one side of the hospital bed mattress [De Mare] or when one side of the mat assembly [Watanabe] is raised, the entire surface upon which the body of the patient is lying is on an incline. Since the Automatic Patient Turner uses a flexible mattress, only the raised longitudinal side of the flexible mattress is on an incline. The other longitudinal side of the flexible mattress is flat. Consequently, the entire body of the patient in the Automatic Patient Turner is not on an incline. The patient does not have the feeling of sliding down an incline as in the case of De Mare's device. De Mare acknowledged the problem that the patient might slide down the incline of the hospital bed in his invention by suggesting that the patient be strapped to the mattress.

### LIST OF FIGURES

FIG. 1: Clinical Manipulator—Prior Art

FIG. 2: Front View of the Flexible Mattress Assembly

FIG. 3: Top View of the Twin Chambers of the Flexible Mattress Assembly

FIG. 4: Side View of the Three Part Flexible Mattress Assembly with Ball Chains

FIG. 5: Top View of the Flexible Mattress Assembly

FIGS. 6A-6L: The Sequence in the Inflation and Deflation of Five Inflatables in the Turning of a Patient 180 degrees

### REFERENCE NUMERALS IN DRAWINGS

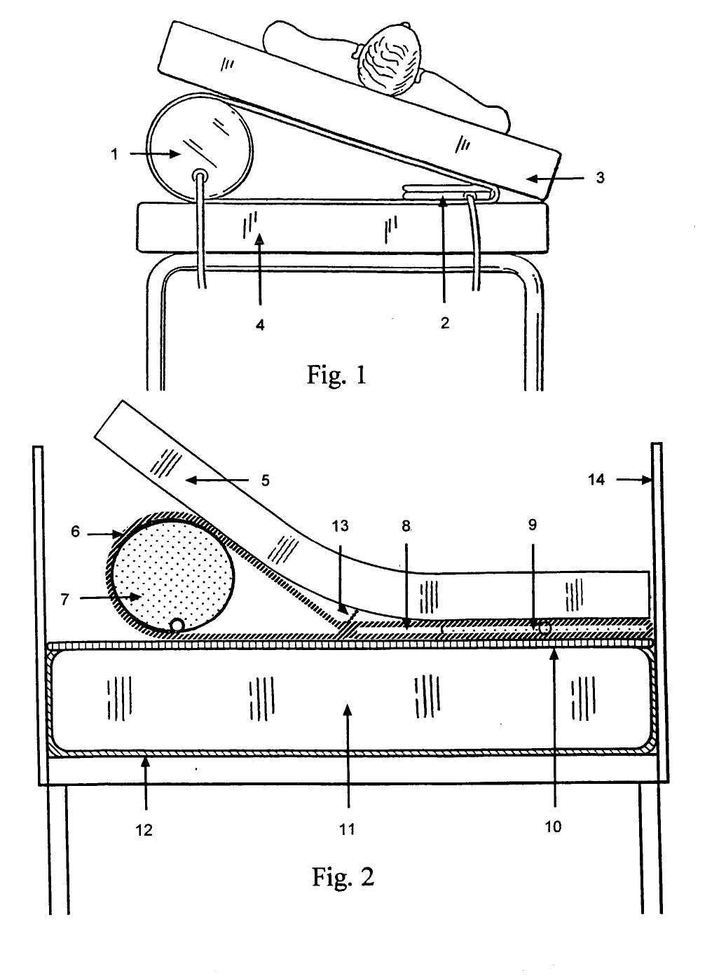

FIG. 1—Clinical Manipulator

1—Right elongated air bag, inflated 2—Left elongated air bag, uninflated 3—Hospital mattress 4—Hospital bedsprings.

FIG. 2—Front View of the Flexible Mattress Assembly.

5—Flexible mattress 6—Right elongated air bag pocket 7—Right elongated air bag, inflated 8—Left elongated air bag pocket 9—Left elongated air bag, uninflated 10—Underneath pad 11—Hospital bed mattress 12—Underneath pad straps 13—Ball chain assembly 14—Padded guardrails.

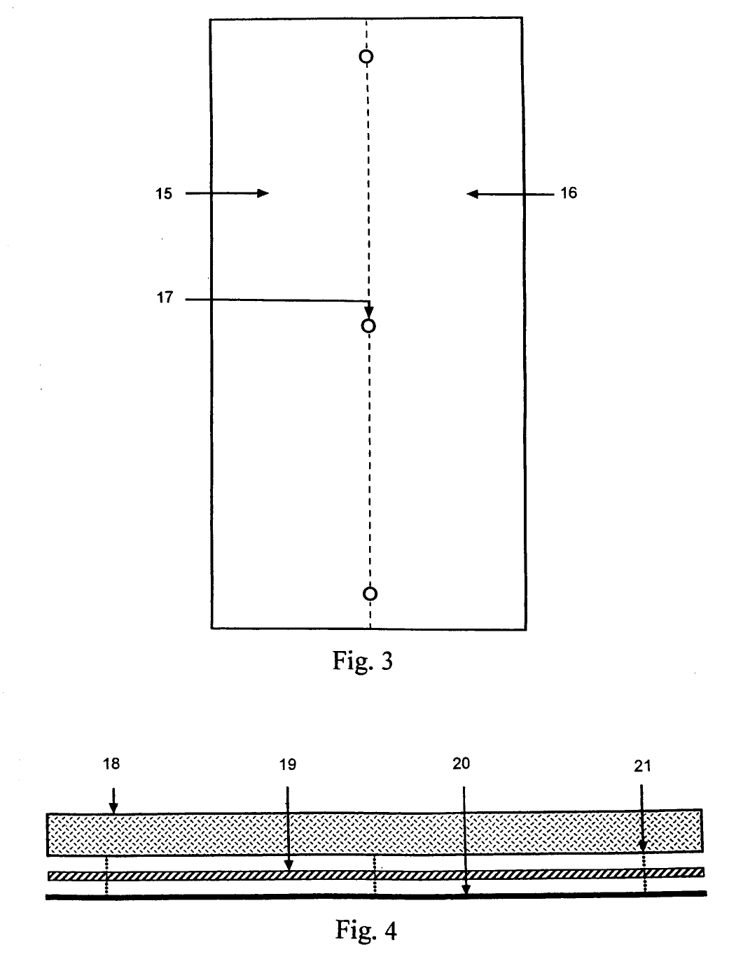

FIG. 3—Top View of the Twin Chambers of the Flexible Mattress Assembly

15—Right elongated air bag pocket where the right elongated air bag is not shown 16—Left elongated air bag pocket where the left elongated air bag is not shown 17—Grommet(s)

FIG. 4—Expanded Side View of the Three Part Flexible Mattress Assembly with Ball Chains

18—Flexible Mattress 19—Twin Chamber 20—Underneath pad 21—Ball Chain(s)

FIG. 5—Top View of the Flexible Mattress Assembly

22—Flexible mattress 23—Right knee air bag pocket 24—Right knee air bag 25—Left knee air bag pocket 26—Left knee air bag 27—Back support air bag pocket 28—Back support air bag pillow 29—Strap(s)

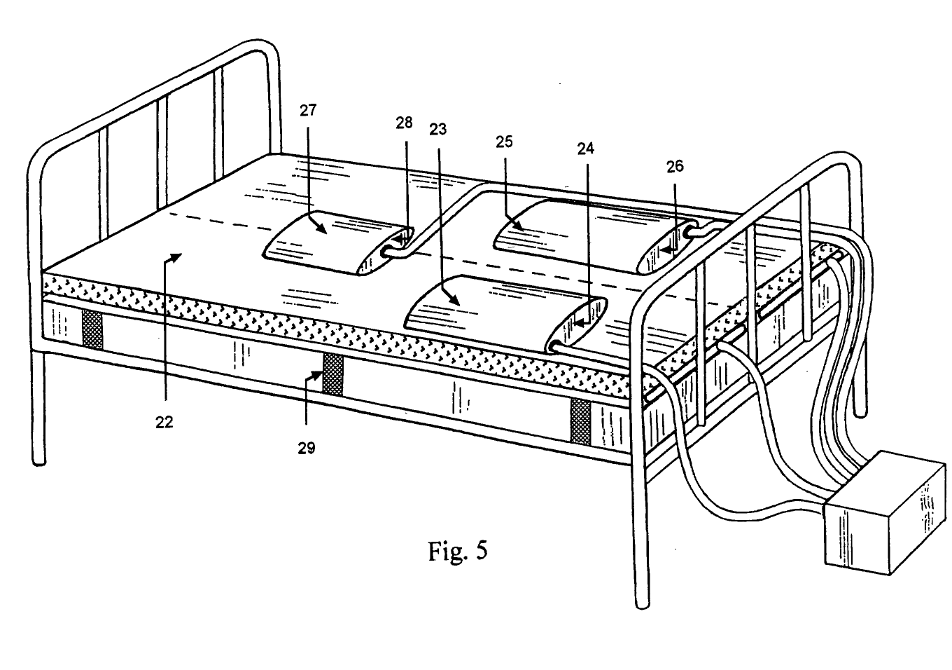

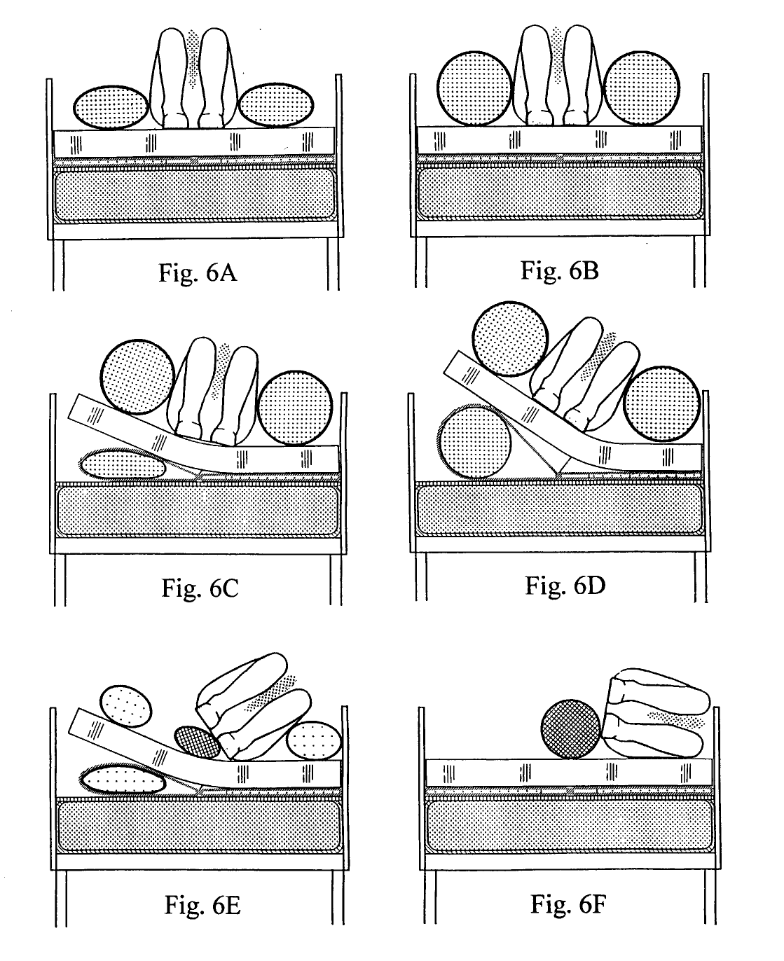

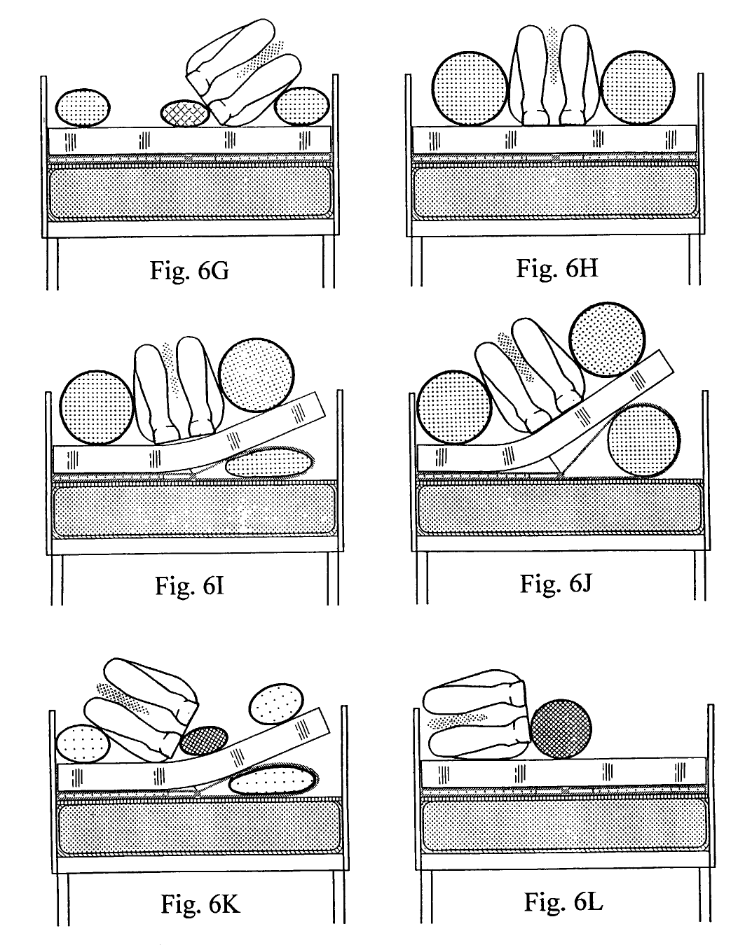

FIGS. 6A-6L—Twelve Diagrams in the Sequence in the Inflation and Deflation of Five Inflatables in the Turning of a Patient 180 Degrees

The inflation and deflation of the five air bags are depicted so clearly in each of the twelve diagrams that reference numerals are superfluous.

Clinical Maniputato—[FIG. 1] Prior Art

To compare De Mare's invention with the Automatic Patient Turner, FIG. 1 in the invention of De Mare is reproduced here. That figure shows a pair of elongated air bags, 1 and 2, within a band located between the underside of the hospital bed mattress 3 and the top of the bedsprings 4. The inflation and deflation of each of the two air bags alternately raises and lowers each side of the rigid hospital mattress thereby tilting the bed mattress. When one side of that mattress is elevated due to the inflation of one of the elongated air bags, the entire body of the patient is on a 45° incline.

The Flexible Mattress Assembly—[FIG. 2]

The Automatic Patient Turner is not a bed but a mattress assembly. On the top of the flexible mattress assembly is a flexible mattress 5. Since the type of flexible mattress used in the invention's prototype was a foam mattress, future references to a foam mattress will cover the use of any flexible mattress or pad. Beneath the foam mattress are two elongated inflatables, 6 and 7 that are placed longitudinally in twin pockets 8 and 9. At the bottom of the mattress assembly is an underneath pad, 10, that is attached to the top of a hospital bed mattress, 11, by straps, 12. The three-part mattress assembly is held together by three 4-inch ball chains, 13. The hospital bed must be equipped with padded guardrails, 14. These three parts are held together by three 4-inch ball chains along the center of the longitudinal axis of the mattress assembly.

Top View of the Twin Chambers of the Flexible Mattress Assembly—[FIG. 3]

The twin chamber contains a right, 15, and a left, 16, air bag pocket and it is sandwiched between the foam mattress and the underneath pad. A grommet, 17, for each ball chain to pass through is placed along the center of the chamber's longitudinal axis. One grommet is in the middle of the center longitudinal axis, and the other two are near each end.

Expanded Side View of the Three Part Flexible Mattress Assembly with Ball Chains—[FIG. 4]

Each ball chain, 18, is fastened to the underside of the foam mattress, 19, passes through a grommet in the twin chamber, 20, and is then secured to the underneath pad, 21. The purpose of the ball chain assembly is not just to secure the foam mattress and twin chamber to the underneath pad. Having the ball chains pass through grommet holes in the twin chamber, allows the foam mattress flexibility while it is at all times attached to the underneath pad. Without the 4-inch leeway permitted by the ball chain assembly, the foam mattress, when one elongated inflatable is inflated, would form a sharp 45° angle rather than a gentle curve. The gentle curve can be seen in FIG. 2. Note that the 4-inch ball chain is what allows the foam mattress to form a gentle curve.

The Top of the Flexible Mattress Assembly—[FIG. 5]

Attached to the top of the foam mattress, 22, are the following: a right knee bag pocket, 23, a right knee air bag, 24, a left knee air bag pocket, 25, and a left knee air bag, 26. Also attached to the top of the foam mattress cover is a back support air bag pocket, 27, and a back support air bag pillow, 28, that lends support to the patient's back during and following the completed turn. Also shown in the figure are the straps, 29, that attach the flexible mattress assembly to the hospital bed.

The Control Box and Panel

Vinyl tubing connects the following five air bags to the control box: two elongated air bags in the twin chamber beneath the foam mattress, the two knee air bags, and one back support air bag pillow that is located on the top of the foam mattress.

There is often the problem of heat generated by a patient lying in bed for long periods of time where the patient perspires, thereby causing moisture. To reduce the probability of this occurring, vinyl tubing with pinholes that is attached to the perimeter of the top of the foam mattress can create a cooling system. Air emitted by the deflation of the air bags can be released through the pinholes, resulting in a periodic stream of air between the top of the foam mattress and the bed sheet The vinyl tubing containing pinholes along the perimeter of the foam mattress is not shown as well as its connection to the control box.

Though the control box in FIG. 5 is shown to be on the floor, it should be placed on a small table at the foot of the hospital bed. Inside the control box are the following items: a small, near silent air compressor, near silent solenoid valves, an air pressure switch, a vacuum switch, a pressure relief valve, a vacuum relief valve, an isolation transformer, a buzzer, a voice chip, and a microprocessor. The microprocessor will control the inflation and deflation of the five air bags in a prescribed, patterned sequence.

On top of the control box is a panel containing the following items: six lighted push button switches—(1) off/on, (2) right turn, (3) left turn, (4) flat, (5) a blinking red reset button next to an LCD display, (6) an air cooling switch—and a green LED indicating that when it is lit, the automatic turning function is operative.

### The Sequence in the Inflation and Deflation of Five Air Bags in the Turning of a Patient 180 Degrees—[FIGS. 6A-6L]

Twelve figures, 6A-6L, show the twelve sequential steps in the inflation and deflation of five air bags that result in turning a patient 180 degrees to one side, and an hour later the return of the patient to the other side.

To differentiate both the two elongated air bags beneath the foam mattress and the two knee air bags on the top of the foam mattress from the one back support air bag pillow, those four air bags have a dotted pattern, while the pattern of the back support air bag pillow in the diagrams is made up of crisscross lines. Furthermore, to distinguish air bags that are inflated or are in the process of inflation from those that are in the process of deflation, the former have a pattern that is denser than those being deflated.

It is necessary for the caregiver to position and prepare the patient prior to activating the Automatic Patient Turner. First, the patient must be placed in the middle of the mattress flat on his or her back with both arms folded across the chest. Specially designed peds are to be placed on the feet of the patient. The sole of each ped has a patch of velcro so the patient's bent knees will be placed in the proper position on the bed sheet where the velcro companion patch is located.

To start the process of automatic turning after the patient has been prepared, the caregiver is to press the on switch. An internal diagnostic test will automatically be conducted to ensure that all the parts including the sensors are operating property. Should the test detect a problem with one of the components, a five second beep will sound, the red light in the reset button will flash with an error message on the LCD display along with a voice message. To end the flashing of the red light in the reset button, the reset button must be pressed indicating that the caregiver is aware of why the red light was flashing.

When the test is successfully completed, a green indicator LED will light and remain lit as long as the Automatic Patient Turner is operative. In the illustration shown in FIG. 6, the left switch was pressed, and the two knee bags begin to inflate while the caregiver bends the knees of the patient to form the apex of an inverted V and places the feet of the patient wearing the peds on the companion velcro patch on the bed sheet. This is to ensure that the legs do not slide. For comfort, a small flat pillow is to be placed between the patient's knees, see FIG. 6A. The caregiver is to hold the knees of the patient in a perpendicular position relative to the flat foam mattress until the two air bags, one on each side of the knees, are fully inflated, see FIG. 6B.

When the two knee bags are fully inflated, the right side of the mattress will then begin to rise with the inflation of the right elongated air bag under the right longitudinal side of the foam mattress, see FIG. 6C. It should be pointed out that the terms right and left are from the perspective of the patient lying in bed. When the right elongated air bag is inflated, that longitudinal side of the foam mattress is then tilted at a 45° angle. However, the bent knees of the patient, which were perpendicular, or on a 90° angle to the foam mattress when it was in a flat position, are now sandwiched between the two fully inflated knee air bags at a 135° angle relative to the stationary underneath pad, see FIG. 6D.

The knees are now supported and resting upon the left inflated knee air bag, the knee air bag on the longitudinal side of the foam mattress that was not raised. At this point, both knee air bags as well as the right elongated air bag begin to deflate. Due to the force of gravity, the bent knees begin to descend with the deflation of the left knee air bag upon which the knees are resting.

Acting as a lever arm, the bent knees slowly pull the body of the patient in the direction of the turn. As the knee air bags and the right elongated air bag begin to deflate, this causes the right longitudinal side of the foam mattress to descend. At the same time a back support air bag pillow starts to inflate, see FIG. 6E. The 180° turn is completed when the left knee bag upon which the bent knees were resting becomes fully deflated, the foam mattress is again in a flat position, and the back support air bag pillow is now fully inflated, see FIG. 6F.

Since the turning process takes approximately three minutes, the patient will remain about fifty-seven minutes on the left side. When that time period is over, the turning of the patient to the other side will start automatically. The back support air bag pillow will start to deflate while the knee air bags begin to inflate, see FIG. 6G. When both knee air bags are fully inflated, the bent knees are again in a perpendicular position, see FIG. 6H.

Then the left longitudinal side of the foam mattress will begin to rise due to the inflation of the left elongated air bag beneath the foam mattress, see FIG. 61. When the left elongated air bag begins to inflate, and that side of the foam mattress approaches a 45° incline, the fully inflated knee air bag on the left side of the foam mattress begins to push the bent knees to a point that is 135 degrees relative to the flat, stationary, underneath pad. When the knee air bags are fully inflated, the knees are now resting on the right knee air bag, see FIG. 6J.

The two knee air bags and the left inflated elongated air bag begin to deflate while the back support air bag pillow begins to inflate. While the bent knees that are resting upon the deflating right knee air bag begin to descend due to the force of gravity, the bent knees act as a lever arm and pull the body of the patient in the direction of the turn, see FIG. 6K. When both knee air bags and the left elongated bag are completely deflated, the patient is now fully turned resting completely on the right side of the flat mattress with the fully inflated back air bag serving as a support pillow, see FIG. 6L.

Whenever the patient is either in a right or left turn position, and the caregiver wishes to end automatic turning and have the patient lie flat on his or her back, the caregiver is to press the flat button. If one of the elongated air bags is inflated, it will then begin to deflate. If the back support air bag pillow is inflated, it will also begin to deflate. The knee air bags, if not inflated, will begin to fully inflate.

After all of these operations are completed, the foam mattress will be flat, and the bent knees, sandwiched between the fully inflated knee bags, will now be brought to a perpendicular position relative to the flat foam mattress. The caregiver is to press the flat button again, and the two knee bags will then begin to deflate while the caregiver lowers the patient's legs to a flat position.

The Unique Features of this Invention

The Automatic Patient Turner will automatically and completely turn the patient every hour. Since periodic turning is most important for the health of a patient, the microprocessor will monitor each component and its operation, and there will be a diagnostic test as soon as the on button is pressed identifying any problem. This will facilitate the servicing and maintenance of the device, thereby lessening its downtime.

This device should only be operated when the hospital bed is in a flat position. To ensure this, four level switches [not listed as parts or shown in any figure] are attached to each corner of the mattress pad along its longitudinal axis and are connected to the control box by a low voltage cable. With the four level switches hooked in series, a break in the low voltage continuity circuit will occur in the event someone raises the head or foot of the hospital bed. Should that occur, and the off/on switch is in an on position, the device will automatically go into a flat mode, the red light in the reset button will blink, the beeper will sound, and the LCD display and voice message will inform the caregiver of the mistake.

The Advantages of the TURNAMATIC™ Automatic Patient Turner

The Automatic Patient Turner is unique in that no other device has been patented or on the market that can truly turn a patient a full 180 degrees. Tests on a prototype of this invention have been completely successful. It takes the Automatic Patient Turner about three minutes to completely turn a patient from one side to the other, and the turning process is more gentle than manual turning. This will enable a sleeping patient to be turned without being awakened, as is often not the case by manual turning.

The Automatic Patient Turner would be most useful in hospital and nursing home settings where the staff is often overloaded and unable to manually turn a patient every two hours. Failing to turn a patient every two hours is the major cause for the development of bedsores.

The Automatic Patient Turner would especially be useful, if not indispensable, to families who wish to care at home for a patient who needs to be turned periodically. Other devices currently in use in hospitals are specially designed hospital beds that merely tilt or reposition a patient. They do not completely turn a patient, and they are too costly for general use at hospitals, nursing homes, or at home for those who require continual turning. The Automatic Patient Turner is not only more effective in turning a patient, but will cost considerably less than the specially designed beds mentioned above. The Automatic Patient Turner will be affordable for use in hospital and nursing home facilities, and especially where a patient is cared for at home.

The burden of having to continually turn a patient by a family caregiver is a major factor inhibiting a patient from being cared for at home, especially when the number of caregivers at home is limited. The cost of having a patient cared for at home is considerably less than having the patient placed in a nursing facility. Last, but not least, a patient's mental health will be enhanced being cared for at home among family rather than at an institution.

### The Automatice Patient Turner Must Only be Used Upon the Written Approval of the Patient's Physician

The condition of each patient is unique. Though this device is safe for general use for immobile, bed ridden patients, each Automatic Patient Turner will have a prominently displayed warning label stating that the device should only be used by a patient upon the advice and written permission of the attending physician. Furthermore, the warning label shall state that the device must only be used on a bed or hospital bed with padded guardrails.

What is claimed is:

1. A flexible mattress assembly that alternately tilts along its longitudinal axis, comprising:
a) a flexible mattress or pad,
b) a twin chamber or any method beneath the said flexible mattress or pad in claim 1(a) containing
i) at least one elongated inflatable located beneath the longitudinal right side of the flexible mattress or pad in claim 1(a),
ii) at least one elongated inflatable located beneath the longitudinal left side of the flexible mattress or pad in claim 1(a),
c) an underneath pad located beneath said elongated inflatables in claim 1(b) where said flexible mattress or pad in claim 1(a) and said elongated inflatables in claim 1(b) are held together and attached to said underneath pad where said underneath pad is strapped to the top of a bed or hospital bed mattress or bed frame.

2. Attached to the top of the said flexible mattress or pad in claim 1(a):
a) at least one inflatable located on the outer right side of the right knee of a person lying upon the flexible mattress or pad in claim 1(a),
b) at least one inflatable located on the outer left side of the left knee of a person lying upon the flexible mattress or pad in claim 1(a).
c) at least one inflatable where the inflation of said inflatable or inflatables lends support to the back side of a person lying upon said flexible mattress or pad in claim 1(a) when said person is in the process of being turned or has been turned.

3. Tubing that is attached to the side, top, or perimeter of any mattress, mattress pad, or mattress cover, containing along its length an array and multiplicity of pinholes that emits air for cooling a patient, for reducing moisture or perspiration, or for any other therapeutic purpose.
